(19) United States
(12) Patent Application Publication
(10) Pub. No.: US 2002/0120783 A1
(43) Pub. Date: Aug. 29, 2002

(54) Broadcasting a presentation or a file to an unlimited number of recipintes through peer-to-peer technology

(76) Inventor: David Evgey, Baltimore, MD (US)

Correspondence Address: Liniak, Berenato, Longacre & White, Ste. 240, 6550 Rock Spring Drive, Bethesda, MD, 20817, US

(21) Appl. No.: 09/793,484

(22) Filed: Feb. 27, 2001

(51) Int. Cl. G06F 15/16

(52) U.S. Cl. 709/247; 709/248

(57) ABSTRACT

Broadcasting a presentation or sending files through the Internet to an unlimited number of recipients using a personal computer and peer-to-peer computing. An initiating computer contacts the members on a list, who in turn contact additional members from the list. The initial users screen image is captured and compressed into a file. The compressed file is then transferred to the users on the list using any electronic medium. Subsequent changes made to the initial user's screen are placed in a compressed file and sent to the users on the list. First file is viewed in conjunction with the files containing the changes, allowing the users on the list to view presentation.

### BACKGROUND OF THE INVENTION

1. Field of the Invention

This invention relates to broadcasting a presentation or any screen content to unlimited number of recipients using a regular PC and peer-to-peer concept. Additionally the invention relates to methods of sending and/or sharing any type of file to/with unlimited number of recipients using a combination of a proprietary E-mail link and file sharing. More specifically, this invention relates to disseminating information, whether a live presentation or a file through standard Internet connections, utilizing the target audience as a medium through which information is rapidly transferred to among themselves without the use of attachments.

2. Description of Related Art

Recently, many companies have realized the importance of peer-to-peer computing. The traditional method of communication consists of a central server. In order to facilitate a large number of individuals, or users, to participate in a broadcast over the Internet, whether by file transfer or live video broadcasting, a central server to individually send the file or video to each intended recipient is required. Where there is a large audience, the enormous flow of information often results in a disruption of service from the host server, or what is more commonly referred to as a “system crash”.

Peer-to-Peer computing moves the actual information from a computer to another computer, known as peer. The information itself is never relayed through, or “hits”, the server. In this case, the central server just controls the flow of information from the transmitting personal computer to the receiving personal computer.

Companies that provide peer-to-peer computing, provide a service where the users submit a list of shared files to a central server. The server maintains each user's list in an index. When a user requests to access or use a file, the central server sorts through the index on file to determine what individual user with that shared file is connected to the central server at that time. The two personal computers are then allowed to transfer the information between each other without having to send the file to or through the central server. While this method eliminates the need for the central server to store each file, the server must still obtain large amounts of information in order to provide individuals with specific requests for information. Organizations still experience system crashes as a result of the vast amount of data that must be kept by the central server.

As businesses expand into new regions, more employees are permitted to work from home. Many Internet users do not have a fast, reliable cable connection. Reliance on the current telephone infrastructure limits the transferability of massive amounts of data in a short time period. In order to train employees on a particular program or to give employees a seminar, the employers must either hold a conference requiring the target audience to appear in person, or find another way to transfer the information. This is not cost effective.

Similarly, there exists a need to provide an effective means to permit access to large files without having to email them as attachments. When a file is required to be sent to an individual via email, it is usually attached to the message. E-mails with large information attached and often return undelivered due to the enormous size.

Therefore, there exists a need for a method in which an oral presentation or a file may be transmitted to many recipients using a standard Internet connection and without exhausting the central server resources until it crashes. Additionally, there exists a need to provide a method in which files at any size may be safely sent without the risk of being returned due to size.

### SUMMARY OF THE INVENTION

It is therefore an advantage of the present invention to provide a method wherein a trainer, or user, may broadcast a presentation and screen content to an unlimited number of users utilizing peer-to-peer. The method captures the master user's screen and sends the contents in a compressed data to another connected user. This user then sends that compressed data to a subsequent user, wherein the subsequent user repeats the process until all parties have received the master user's screen. The master user then begins the presentation wherein only the changes made to the screen picture during the presentation are recorded and sent to the viewing users in the chain. The users need not necessarily have the actual program about which the presentation is given. The audience will see what it is the master user is doing through data transmission of the master's screen content.

Similarly, the present invention provides the ability to place a file in a shared folder on a computer server. When a user wishes to send that file using email, a link is provided on the email rather linking to a site for uploading the file, that link permits the receiving user access to search who hosts that file for direct retrieval of the file directly from the sender's computer. In order to identify that file uniquely from other files, an algorithm called MD5 is used to compute a number which will identify that file Accordingly, access to the file from a remote location is denied without having received the link within an email.

For example, two users are sharing two files with the same name: Monthly-Marketing.Doc. The content of these documents is completely different from each other. How can AdrenaMail, than, identifies one from each other?.

AdrenaMail creates a thirty-two character long identification, which uniquely identifies the file These 32 characters are the result of well know algorithm called MD5. While it is possible to uniquely identify the entire content of the document using the so called MD5 hash, in order to save time and computing resources AdrenaMail computes only the first 300,000 characters in the file which is sufficient for the task specially if it also lists with size of the file. A typical identification might look as follows:

C:\marketing\market-monthly.doc\F852FEE364ID8CBE6338BIB0684305C9\39229

Which lists the path information, the actual name of the file, followed by 32 characters which uniquely identify the file and the file size in bytes (39,229 bytes).

Additionally AdrenaMail saves the information about the size of files which helps to more accurately identifying it.

These advantages and other novel features of the present invention will become apparent in the following detailed description of the invention.

### BRIEF DESCRIPTION OF THE DRAWINGS

FIG. 1 is a schematic view depicting the connection between users.

FIG. 2 is a schematic view depicting the process of sending a file to an unlimited number of recipients.

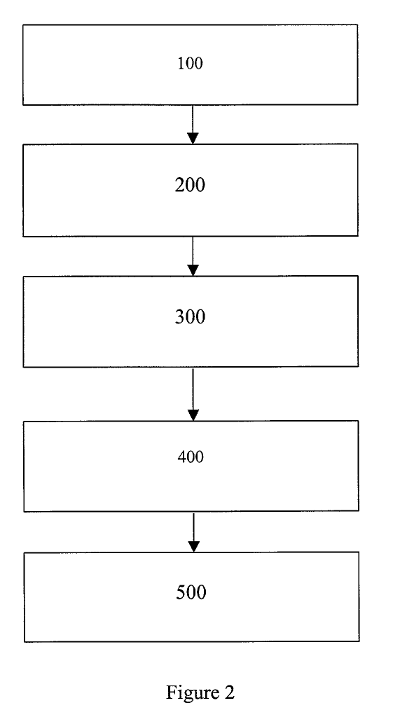

### DETAILED DESCRIPTION OF THE PRESENT INVENTION

The features of the invention as explained above allow for the broadcasting of a presentation to a target audience using a standard Internet connection. Additionally, the invention features the ability to place files on a shared server and allow access to remote users via a link that may be included in the original email from the sender.

The present invention, hereinafter “AdrenaMail”, achieves the broadcast of a presentation to an unlimited number of persons via any Internet connection, e.g., cable modem, DSL, telephone modem.

When a presentation is given, a trainer gives an instructional period or lesson on a particular subject to a target audience. The audience can range in size from a few dozen people to thousands of people. Presentations can involve voluminous amounts of information transferred to the audience. The size and scope of most presentations does not facilitate the use of a standard Internet connection as a medium without enormous significant upgrade, costing valuable resources.

AdrenaMail allows a trainer to broadcast a presentation over the Internet. The trainer begins by starting AdrenaMail, then opening the presentation's subject program

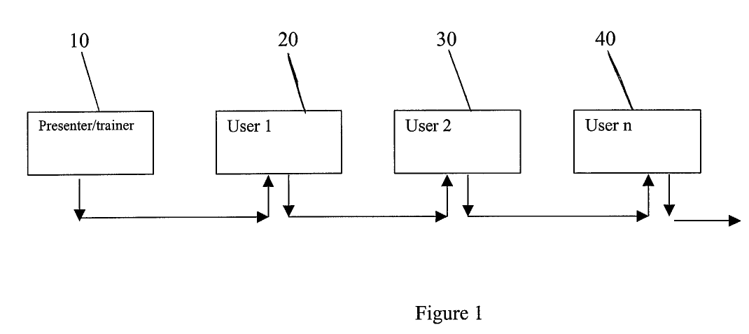

The trainer must begin the broadcast of the presentation by entering a virtual “room” in which all trainees are present. Conceptually, imagine the trainer is at the top of the pyramid 10, referred as the first tier. The trainer selects a list from either the memory of his computer or from a network server, as depicted in FIG. 1. AdrenaMail then initiates contacting the target audience by selecting at least one user within that target audience and attempts to connect the user 20. The users contacted by the trainer are conceptually viewed as the second tier. If there are many users within the target audience, the audience becomes an instrumental link in facilitating connection between additional users. Having just received a connection initiation from the trainer, the users, conceptually on tier two, attempt to contact with at least one additional user 30 from the target audience. The newly contacted users in the audience make up tier three. AdrenaMail continues to contact users in the target audience utilizing the audience's computers and connections as a means to facilitate transfer of information until all users 40 have been contacted. AdrenaMail monitors how many users are connected to the network at all times. Should a user lose the network connection, AdrenaMail automatically finds another user from the end of the list, usually found on the bottom tier, to replace the “lost” user so that the presentation may continue uninterrupted. The “lost” user's connections are then reconnected via the new user.

Once a connection with the audience and all members has been established, the trainer then begins the presentation by opening the subject program. AdrenaMail “captures” the image on the trainer's screen using any of the existing methods as is known to one skilled in the art. The image is saved as data in a format that supports viewing as a picture, e.g., BMP, JPEG, GIF, and affords minimum size requirements. The voice of the trainer is also captured and the combination of the screen image and the voice is compressed by AdrenaMail and sent by the trainer's computer to the next user connected to the network. The voice and images are transmitted in different channels, synchronized with the presentation. This receiving computer in the network transfers the same file just received to the next user in the chain within the network. The process ends only when the presentation comes to an end. The users receiving the file from the trainer are on tier two, while the tier two users send the file to the tier three users whom they are in contact with. Since the file being transferred is relatively small in size, this method facilitates the ability to transfer information and broadcast presentations to numerous users despite a slower Internet connection. Similarly, since AdrenaMail captures the trainer's screen image, the audience need not have the same program that the trainer is using. AdrenaMail permits the trainer to vocally describe what he is doing and AdrenaMail will transmit that voice to the audience.

Another embodiment permits the audience to provide immediate feedback to the trainer using a chat box provided in the program. The trainer may scroll through the feedback and answer any questions as in needed.

As the trainer proceeds with the presentation, several aspects of the trainer's screen will change or be altered. AdrenaMail periodically captures the content of the entire screen or the “screen shots” and transmits that content periodically to the next user in the room.

There are several embodiments in which this may be done. In one embodiment, for each move of the cursor, AdrenaMail captures the entire screen including the position of the mouse over the screen as well as the entire background. This is the least desirable embodiment, as it does not significantly reduce the transferring file adequately.

An alternative embodiment captures the background once in the beginning of the presentation and thereafter only captures the elements of the screen that has changed. Since this embodiment generates a smaller file, the overall transfer of data is completed faster than having to capture the entire screen each time. This requires computers to use less memory and eliminates costs associated with large file transfers.

The following is an illustration of how AdrenaMail assists presentation broadcasting. Let us say that a trainer wishes to present a tutorial on Microsoft Word to five thousand users. The trainer has a list of the users and their addresses that he sends to the AdrenaMail server. The trainer opens Word on his computer. AdrenaMail then captures the content of the trainer's screen and generates a compressed data. This data is sent to the first trainee in the list. The trainee then sends the data to a third user on the list. This continues until each and every user on the list is contacted. Essentially, each user receives a packet of information, containing the initial screen image of the presentation in the transfer and transmits that data to a subsequent user.

During the Word tutorial, AdrenaMail captures the changes made by the trainer and sends it as a subsequent compressed data to all users in the audience automatically using the above-mentioned procedure. All data received is displayed along with any accompanying voice transfer. As the trainer explains what is occurring, his voice is transmitted to the audience. When the audience has a question for the trainer, they may type into a chat box wherein the trainer may scroll through and answer at his leisure. The questions and answers are automatically transmitted to all participants of the broadcast. Using the chat box, or the trainer may address the remark in the oral presentation. Any above described embodiments may be used in conjunction with this method. The process of transmission is automatic and is executed during the entire presentation or tutorial.

The second feature of the present invention is a method of sending multimedia files or any files for that matter via peer-to-peer technology to multiple recipients. AdrenaMail includes a service combining E-mail service with file sharing capability. AdrenaMail enables users to E-mail a message with a special link pointing to the file. The recipient of the message clicks on that link, at which time AdrenaMail automatically launches a search on all computers who are connected to the service and host that file which AdrenaMail can identify. In order to accomplish this, AdrenaMail uses a MD5 computation algorithm, as is known in the art, and show the results in a form of “hits”. The recipient, at this point can determine from which user or computer to retrieve the file.

The benefits of sending files using this method are obvious and clear. Instead of keeping the central server busy and exhausting its resources with the sole task of sending big files, AdrenaMail enable its users to retrieve the file from anyone who downloaded it. Thus increasing dramatically reducing the workload from the central server. The recipient becomes an additional depository for the file. AdrenaMail automatically includes the recipient's computer for future inquiries regarding that particular file. This method enables users of AdrenaMail to send or share their files with any number of recipients without causing the central server any delay or a crash.

Thus, AdrenaMail provides a unique link that enables recipients of that E-mail message to access the shared file and retrieve it from any one of the users hosting it. In order to protect users from unauthorized usage, the sender can key in a password which only users with that password can complete the retrieval process of the file.

In an alternate embodiment, a file is saved to a server similar to the previous embodiment. A user attaches the link to the file in the outgoing message 100. A recipient using any email application selects the link in the message text 200. The file is described precisely in the attached link in order to uniquely identify that particular file from other files with similar names. AdrenaMail is then automatically launched and begins to search for that particular file on the network in which it is stored 300. AdrenaMail then returns the matches of wherein the network the file can be retrieved 400. By clicking the file once again, the file is downloaded directly from the sender's computer to the recipient's computer 500. At this point, any recipient that has successfully downloaded the attached file, becomes a depository and a source for retrieving that file by other recipients. Another alternative of this particular embodiment permits the recipient to view the file while its loading or stream the file, mostly in an audio or video format.

The foregoing invention has been shown and described with reference to several preferred embodiments, it will be understood that various changes in form and detail may be made without departing from the spirit and scope of the present invention.

1. A method of sending a file using an electronic medium to transfer files from one computer to another, comprising the steps of:
saving a list of users on a central server,
accessing said list to generate a connection between a first user and at least one additional user on said list,
capturing an initial image displayed on a monitor (or a “screen shot”) of said first computer,
compressing said initial image into a first compressed data,
transferring said data compressed data through an electronic medium to said at least one additional user whereby said at least one additional user views said first compressed data,
capturing a change made to said initial image to thereby define a changed image,
compressing said changed image into a second compressed file,
transferring said second compressed file through said electronic medium to said at least one additional user whereby said at least one additional user simultaneously views said first compressed file and said second compressed file.

2. The method of claim 1, further comprising the steps of repeating said step of capturing a change and compressing said changed image to thereby transfer an amount of information necessary to relates changes to said initial image.
